(19) United States
(12) Patent Application Publication
(10) Pub. No.: US 2006/0200368 A1
(43) Pub. Date: Sep. 7, 2006

(54) Healthcare Coordination, Mentoring, and Coaching Services

(75) Inventor: William D. Casey, Hammond, WI (US)

Correspondence Address: MERCHANT & GOULD PC, P.O. BOX 2903, MINNEAPOLIS, MN, 55402-0903, US

(73) Assignee: Health Capital Management, Inc., River Falls, WI (US)

(21) Appl. No.: 11/276,489

(22) Filed: Mar. 2, 2006

Related U.S. Application Data
(60) Provisional application No. 60/658,499, filed on Mar. 4, 2005.

(51) Int. Cl. G06F 19/00

(52) U.S. Cl. 705/3

(57) ABSTRACT

A system for coordinating healthcare and services for an individual includes an assessment module programmed to collect data from the individual associated with internal and external factors related to the individual, an analysis module programmed to analyze the data and to recommend services based on the analysis, and a graphical module programmed to graphically represent the analyzed data. A method for coordinating healthcare and services for an individual includes collecting data from the individual associated with internal and external factors related to the individual, analyzing the data to recommend services, and generating a graphical representation of the analyzed data.

### TECHNICAL FIELD

Embodiments disclosed herein relate to healthcare coordination, mentoring, and coaching services.

### BACKGROUND

Healthcare is an ever-changing industry. Over time, the healthcare industry has adopted changes to address medical advances, technological breakthroughs, legislative developments, and insurance carrier requirements. These ongoing changes have placed demands on healthcare providers and administrators that are passed, inevitably, to the individuals receiving the care.

Most individuals are too busy to coordinate their personal healthcare adequately and effectively. Those individuals who do make time are bombarded by an onslaught of resources and information. For example, Internet websites such as WebMD, sponsored by healthcare entities, along with printed and televised advertisements for pharmaceuticals, are now standard industry practices for marketing to and educating potential patients. Deciphering the healthcare lexicon in layman's terms is laborious and time-consuming. Furthermore, individuals often lack the expertise needed for coordinating appropriate personal healthcare. For these reasons, what is needed is a way to provide individual assistance to patients so that they can make personal healthcare management and service decisions.

Healthcare modalities generally fall in two practices: reactive and proactive. Traditionally, the reactive approach is associated with the practice of conventional healing, for example, western medicine, which is primarily science-based, such as diagnosis and treatment. In contrast, the proactive approach is associated with the practice of alternative methods, for example, eastern medicine, which is principally wellness-based, such as directing one to optimal health or preventive care. However, the healthcare industry rarely integrates these two practices, in order to provide a comprehensive approach for personal healthcare. Often, a patient must opt for one approach and exclude the other. What is needed is a way to provide for an integral practice of modalities for personal healthcare coordination services.

Providing an integral practice of personal healthcare requires an evaluation of both internal and external factors that affect a patient's health. These factors may include, for example, the physical, psychological, social, and occupational conditions of daily living. Identifying internal and external factors usually includes gathering information about a patient's family medical history, present lifestyle, and future objectives. Once these factors are identified, healthcare coordination services are planned to address a patient's individual needs. A healthcare coordination services plan normally includes verbal communication and written documentation, without collaborative effort between provider and patient. For example, a potential outcome is perhaps a patient experiencing difficulty following his/her healthcare provider's orders. Additionally, patients rely on follow-up appointments and seldom interpret their medical records. What is needed is a way to provide a collaborative healthcare plan that services internal and external factors of personal healthcare coordination services.

Healthcare providers frequently develop a relationship with their patients that includes spouses and family members or provide services through a benefits carrier to employees. This presents an opportunity for healthcare providers to leverage their standard of care to patients who share internal and external factors for a holistic approach to diagnosis, treatment, and preventive care. For example, a healthcare provider can treat both parent and child for genetically-inherited conditions, counsel a couple for marital discord, and guide stress-management among colleagues in the workplace. What is needed is a way to provide for an integral practice for the coordination of the diagnosis, treatment, preventive care, and optimal healing of patients who have a spousal, genealogic, or professional relationship of personal healthcare coordination services.

A solid healthcare coordinator-patient relationship can bring forth a lifetime of optimal health and well-being. However, many healthcare providers are only called upon in critical times of immediate need for medical attention. An example is the patient who calls his/her healthcare provider as the result of an emergency, injury, illness, or crises. In contrast, a patient can ideally regard his/her personal healthcare coordinator as a mentor and form a valuable partnership with the healthcare coordinator, in order to maintain optimal health and well-being. What is needed is a way to provide for an integrated/integral practice, in order for healthcare coordinators to mentor patients for a lifetime of personal healthcare coordination services.

Healthcare providers typically have systems for accounting, insurance, and administrative functions. However, many of these enterprise-wide operation systems are too inflexible to provide the patient with the diagnostic information required to support healthcare coordination services in a managed care environment. For example, the current system support used by healthcare providers is incapable of providing sufficient coordinated decision support, such as the most appropriate medical aid, the best possible service, comprehensive and in-depth analysis, selection of the appropriate wellness options/schemes, and presentation of the data for personalized patient care. What is needed is a way to provide personal healthcare coordination services.

Healthcare providers have come to rely on a network of referrals in order to build a successful practice and appraise the expertise of their colleagues' healthcare specialty. A network of referrals ensures that patients are receiving the best possible care. For example, an Olympic athlete with a knee injury would prefer to be seen by the leading physician in the specialty of orthopedics. A carefully cultivated and maintained network of referrals is an invaluable resource for connecting the best healthcare providers with in-need patients. What is needed is a way to provide healthcare coordination for the diagnosis, treatment, and preventive care of patients who benefit from a network of referrals for personal healthcare coordination services.

Some methods for healthcare coordination services are known in the industry. For example, U.S. Pat. No. 5,937,387 entitled “System and method for developing and selecting a customized wellness plan” (“'387 patent”) describes a system for and method of developing a customized wellness plan for measuring a user's wellness by determining a user's physiological age. However, the systems and methods described in the '387 patent do not offer a way to provide integrated healthcare coordination services. Further, the systems and methods described in the '387 patent do not integrate patient coordination, reactive and proactive practices, internal and external factors, relationship conditions, systems of support, and network of referrals.

There is therefore a need for systems and methods for providing personal healthcare coordination services.

### SUMMARY

Example embodiments described herein relate to systems and methods for providing healthcare coordination services for diagnosis, treatment, and preventive care.

According to one aspect, a computer system for coordinating healthcare and services for an individual includes an assessment module programmed to collect data from the individual associated with internal and external factors related to the individual, an analysis module programmed to analyze the data and to recommend services based on the analysis, and a graphical module programmed to graphically represent the analyzed data.

According to another aspect, a computer system for coordinating healthcare and services for an individual includes an assessment module programmed to collect data from the individual associated with internal and external factors related to the individual using a series of questions, wherein the internal factors include emotional/mental, physical, and spiritual, and wherein the external factors include occupational, relational, and economics, an analysis module programmed to analyze the data and to recommend services based on the analysis, and a graphical module programmed to generate an assessment results chart to graphically represent the analyzed data, wherein the assessment results chart includes representations of average current scores and average desired scores for the individual.

According to yet another aspect, a method for coordinating healthcare and services for an individual includes: collecting data from the individual associated with internal and external factors related to the individual; analyzing the data to recommend services; and generating a graphical representation of the analyzed data.

The above summary is not intended to describe each disclosed embodiment or every implementation. The figures and the detailed description that follow more particularly describe example embodiments. While certain embodiments are illustrated and described, these embodiments are provided for illustrative purposes and should not be construed as limiting.

### DESCRIPTION OF THE DRAWINGS

FIG. 1 illustrates a block diagram of an example system for improving methods of commerce for providing healthcare coordination services system.

FIG. 2 illustrates an example table of assessment data.

FIG. 3 illustrates an example chart of assessment results.

FIG. 4 illustrates an example table of services data.

FIG. 5 illustrates an example chart for periodic personal assessment.

FIG. 6 illustrates an example method of providing personal healthcare coordination services.

### DETAILED DESCRIPTION

Example embodiments described herein relate to systems and methods for providing healthcare coordination, mentoring, and coaching services. In example embodiments, these services are provided for diagnosis, treatment, and preventive care.

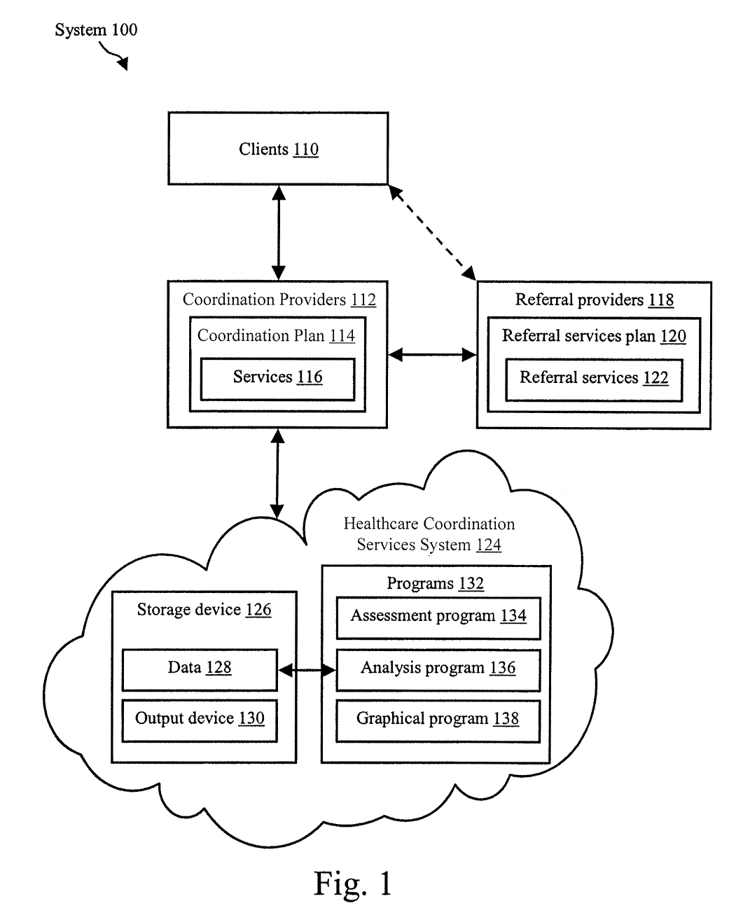

FIG. 1 illustrates a functional block diagram of an example system 100 programmed to provide healthcare coordination, mentoring, and coaching services. Generally, system 100 is configured to coordinate one or more of the following process areas: assessment; education; motivation; practice; accountability; measurement; and outcomes.

System 100 includes client 110, coordination plan 114, services 116, referral providers 118, referral services plan 120, referral services 122, healthcare coordination services system 124, storage device 126, data 128, output device 130, programs 132, assessment program 134, analysis program 136, and graphical program 138.

Clients 110 are representative of any individual or group recognized and suitable for receiving healthcare coordination services. Clients 110 are, for example, at least one or more individuals, or at least one or more groups such as a family, employees, and other parties that have a spousal, genealogic, or professional relationship.

Service coordination providers 112 are representative of any individual or group recognized and suitable for providing healthcare coordination services. Service coordination providers 112 are, for example, any party that is occupationally qualified, certified, and/or licensed for providing healthcare coordination services, as is known to those skilled in the art. Examples of service coordination providers 112 are any medical, psychological, and physical fitness professional, such as an internist, therapist or personal trainer, as are known to those skilled in the art.

Services coordination plan 114 is representative of any informative documentation used for providing healthcare coordination services under the authorship, observation, and guidance of service coordination providers 112. Examples of services coordination plan 114 are medical records, treatment diaries, physician instructions, and progress reports.

Services 116 are representative of any healthcare coordination services for the diagnosis, treatment, and preventive care of clients 110. Services 116 are intended to address both internal and external factors that affect clients 110. As both internal and external factors are well known, these attributes are not described in detail herein. Examples of services 116 are nutritional counseling, meditation, and yoga, as are known to those skilled in the art.

Referral providers 118 are representative of any individual or group recognized and suitable for providing healthcare coordination services outside of, or in addition to, those that are offered by service coordination providers 112. Referral providers 118 are, for example any third party participants, such as industry participants, individuals, businesses, and other entities that are occupationally qualified, certified, and/or licensed for providing healthcare management services. Another example of referral providers 118 is any individual or group who supplies, provides, and contributes resources, materials, equipment, transportation, delivery, and manual labor for healthcare coordination services. Examples of referral providers 118 are services such as assisted living, hospice care, and shuttle-bus transportation. In the example shown, referral providers 118 are an entity separate from clients 110 and service coordination providers 112. In alternative embodiments, the same entity can perform one or more of the services of referral providers 118 and service coordination providers 112.

Referral services plan 120 is representative of any informative documentation for providing healthcare coordination services under the authorship, observation, and guidance of referral providers 118. Examples of referral services plan 120 are provider instructions, strategies, patient expectations, and course of action documentation. In example embodiments, referral services plan 120 is an entity separate from coordination plan 114, although other configurations are possible.

Referral services 122 are representative of any healthcare coordination services for the diagnosis, treatment, and preventive care of clients 110 and are provided by referral providers 118. Referral services 122 are intended to address both internal and external factors that affect the health of clients 110. As healthcare coordination services are well known, these attributes are not described in detail herein. Examples of referral services 122 are substance abuse counseling, anger management, and instructional dance classes, as are known to those skilled in the art. In example embodiments, referral services 122 are an entity separate from services 116, although other configurations are possible.

Healthcare coordination services system 124 is an interrelated system of computer programs, storage devices, and data. Healthcare coordination services system 124 is utilized by service coordination providers 112 to improve the process of providing personal healthcare coordination services to clients 110. Typically, standard systems, such as healthcare coordination services system 124, include a user-friendly input device (not shown). For example, a standard input device known to those skilled in the art is a touch-screen, a mouse, or a keyboard that enables service coordination provider 112 to enter information.

Storage device 126 is a standard storage device, such as a hard disk drive and/or database. Other examples of storage device 126 may include long-term storage devices, such as a floppy disk, compact disc, or universal serial bus (USB) drive. Storage device 126 is used for storing data, for example, electronic data, metadata, and database records. An example of storage device 126 is a Microsoft SQL S2erver 2000 from Microsoft Corporation of Redmond, Wash., or an Oracle Enterprise Database System from Oracle Corporation of Redwood City, Calif.

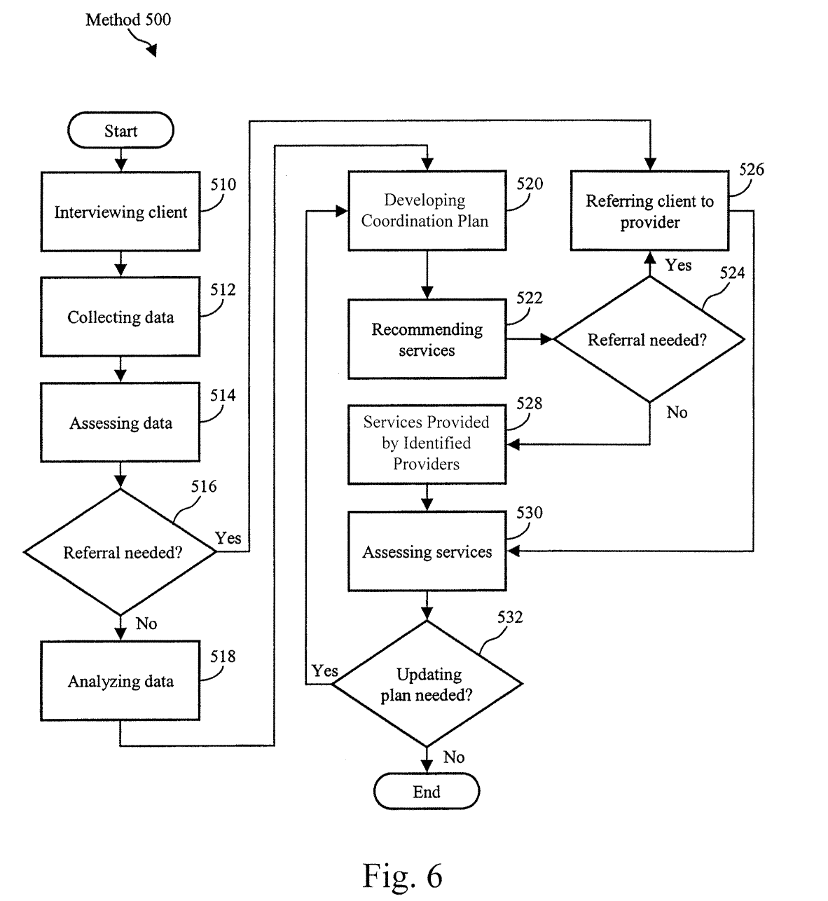

Data 128 is representative of information contained within storage device 126 related to coordination plan 114 that has been translated into a form that is more convenient to move or process such as, for example, standard information that is in electronic or document format. Examples include as contact information, database records, documents, pictures, and sound recordings, as is known to those skilled in the art. Data 128 is described in more detail in reference to FIG. 6.

Output device 130 is at least one standard output device, such as a thermal printer, laser printer, monitor, peripheral or other hardware component. Output device 130 is used for the communication functions of healthcare coordination services system 124. For example, output device 130 is used for dispensing printed information. In a further example, output device 130 is a more sophisticated device that displays graphical information for providing healthcare coordination services.

Programs 132 are representative of a group of computer applications that assist service coordination providers 112 in providing personal healthcare coordination services.

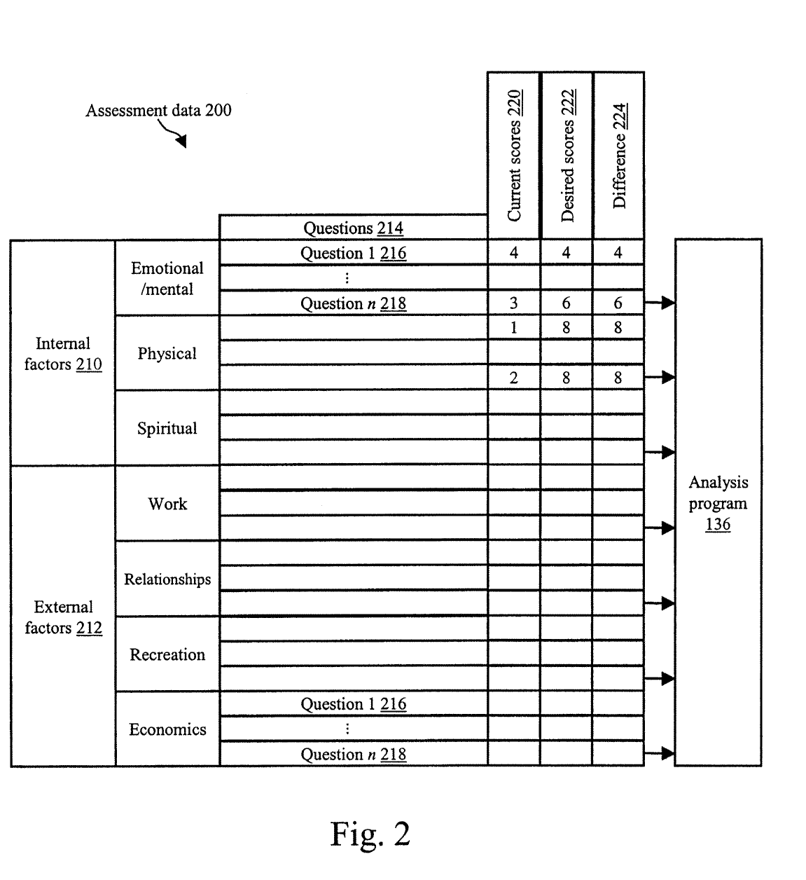

Assessment program 134 is representative of a computer application that assists service coordination providers 112 in assessing the personal healthcare of clients 110. More specifically, assessment program 134 is used to coordinate service coordination providers 112 during their assessment of clients 110, as is described in more detail in reference to FIG. 2, and to receive inputted data 128 from service coordination providers 112 about the assessment.

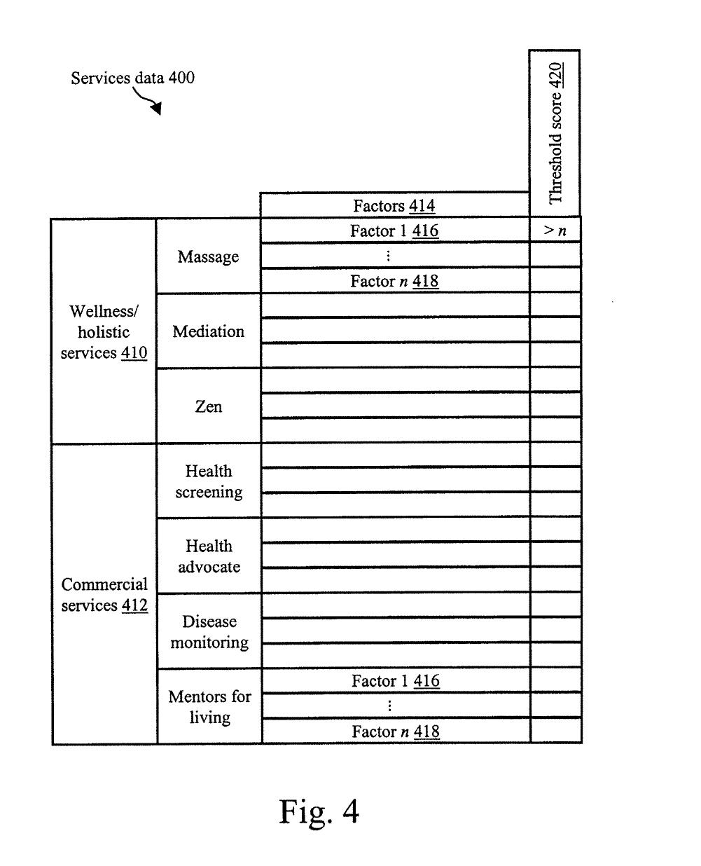

Analysis program 136 is representative of a computer application or algorithm that performs specific calculations about the personal healthcare of clients 110. More specifically, analysis program 136 is used to retrieve the assessment results of data 128 for a particular client 110 and calculate, for example, a service to recommend, based on the assessment of the client. This assessment is described in more detail in reference to FIG. 4.

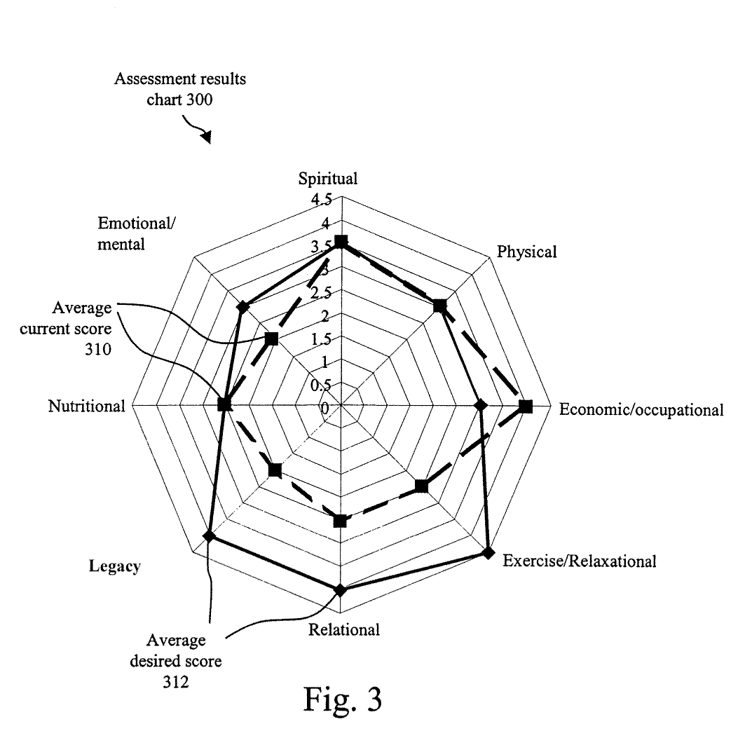

Graphical program 138 is representative of a computer application that provides a graphical representation of the personal healthcare of clients 110. More specifically, graphical program 138 is used to retrieve the assessment results of data 128 for a particular client 110 and provide, for example, a graphical analysis. The graphical analysis is described in more detail in reference to FIG. 3.

In the illustrated embodiment, assessment program 134, graphical program 138, and analysis program 136 are separate programs. In alternative embodiments, assessment program 134, graphical program 138, and analysis program 136 can all be implemented in one or more programs.

FIG. 2 illustrates an example table of assessment data 200 that is an example of data 128 of system 100 and that is suitable for use to improve methods of providing healthcare coordination services. Assessment data 200 includes internal factors 210, external factors 212, questions 214, question 1 216, question n 218 current scores 220, desired scores 222, and difference 224.

Internal factors 210 are representative of positive and negative states of the well-being of clients 110, such as optimal physical, emotional/mental, and spiritual conditions, that effectuate healthcare coordination services.

External factors 212 are representative of positive and negative states of the well-being of clients 110, such as work, relationships, recreation, and economics that effectuate healthcare coordination services.

Questions 214 are representative of any series of planned and unplanned questions used to inquire as to the past, present and future health of clients 110 and provide healthcare coordination services for the diagnosis, treatment, and preventive care of clients 110. For example, service coordination providers 112 utilize programs 132, such as assessment program 134, which is populated with questions 214. Questions 214 are derived from and based on both internal factors 210 and external factors 212 that affect clients 110. Questions 214 are data elements that are utilized algorithmically by programs 132 as a means to solve a recurrent problem actuated by healthcare coordination services system 124. Specific examples of questions 214 include inquiries about family medical history, current health conditions, and lifestyle interests and activities.

Question 1 216 is representative of the first planned and unplanned question 214 used to inquire as to the past, present and future health of clients 110 and provide healthcare coordination services for the diagnosis, treatment, and preventive care of clients 110. An example of question 1 216 is the initial question commonly asked by healthcare coordinators.

Question n 218 is representative of the infinite number of planned and unplanned questions 214 used to inquire as to the past, present and future health of clients 110 and provide healthcare coordination services for the diagnosis, treatment, and preventive care of clients 110. An example of question n 218 is an infinite number of questions commonly asked by healthcare coordinators.

Current scores 220 are representative of numerical answers, provided by clients 110 in response to a quantitative assessment by service coordination providers 112, that describe the current state of health of clients 110. For example, current scores 220 is a numerical value, on a scale of one to ten, that clients 110 answer in response to a specific question 214 about, for example, a physical internal factor affecting clients 110. Current scores 220 are data inputs of assessment program 134 that are utilized algorithmically as a means to solve a recurrent problem actuated by healthcare coordination services system 124. For example, results of current scores 220 are used by analysis program 136, as illustrated in reference to FIG. 2, in determining a coordination plan 114 for client 110. For healthcare coordination services, current scores 220 is a data output separate from desired scores 222 and difference 224, which are described in more detail below.

Desired scores 222 are representative of numerical answers, provided by clients 110 in response to a qualitative assessment by service coordination providers 112, that describe the desired state of health of clients 110. For example, desired scores 222 is a numerical value, on a scale of one to ten, that clients 110 answer in response to a specific question 214 about, for example, a physical internal factor affecting clients 110. Desired scores 222 are data inputs of assessment program 134 that are utilized algorithmically as a means to solve a recurrent problem actuated by healthcare coordination services system 124. For healthcare coordination services, desired scores 222 is a separate data output from current scores 220 and difference 224, which is described in more detail below. Difference 224 is representative of the mathematical difference between numerical answers provided by clients 110, in response to an assessment by service coordination providers 112 that describes the current state of health of clients 110 versus the desired state of health of clients 110. For example, difference 224 is a numerical value, on a scale of one to ten, calculated as the difference between current scores 220 and desired scores 222. Difference 224 is a calculated value that is utilized algorithmically as a means to solve a recurrent problem actuated by healthcare coordination services system 124. For healthcare coordination services, difference 224 is a separate data output from current scores 220 and desired scores 222.

FIG. 3 illustrates an example assessment results chart 300 that is an example of a graphical analysis created by graphical program 138 using assessment data 200 and is suitable for use to improve methods of providing healthcare coordination services. More specifically, assessment results chart 300 provides a graphical view of assessment data 200 to be used by service coordination providers 112 in determining a coordination plan 114. Assessment results chart 300 includes average current scores 310 and average desired scores 312.

Average current scores 310 are representative of the numerical average of answers provided by clients 110 in response to a quantitative assessment by service coordination providers 112 that describe the current state of health of clients 110. For example, average current scores 310 is a numerical value, on a scale of one to ten, averaged mathematically for all current scores 220 in response to questions 214 that apply to a specific internal factor 210 or external factor 212. Average current scores 310 is a value that is utilized algorithmically as a means to solve a recurrent problem actuated by healthcare coordination services system 124. For healthcare coordination services, average current scores 310 is a separate data output from average desired scores 314, which is described in more detail below.

Average desired scores 312 are representative of the numerical average of answers provided by clients 110 in response to a qualitative assessment by service coordination providers 112 that describe the desired state of health of clients 110. For example, average desired scores 312 is a numerical value, on a scale of one to ten, averaged mathematically for all desired scores 222 in response to questions 214 that apply to a specific internal factor 210 or external factor 212. Average desired scores 312 represent minimum scores that would be desired by clients 110, as individual desired scores 222 given in response to questions 214 may be higher than average desired score 312. Average desired scores 312 is a value that is utilized algorithmically as a means to solve a recurrent problem actuated by healthcare coordination services system 124. For healthcare coordination services, average desired scores 312 is a data output separate from average current scores 310.

Assessment results chart 300 is a snapshot of the current and desired health states of client 110. Service coordination providers 112 try to expand outwardly those internal factors 210 and external factors 212 in which the average current score 310 of a client 110 is less than average desired score 312. It is further understood that service coordination providers 112 try not to move the average current score 310 of a client 110 to less than the average desired score 312, unless such results would be consistent with the desire of compensating for another factor, such as a different internal factor 210 or external factor 212. For example, client 110 may wish to decrease average current score 310 of the ‘economic/occupational’ external factor 212 in order to increase the average current score 310 of the ‘emotional/mental’ internal factor 210, as illustrated in reference to FIG. 3.

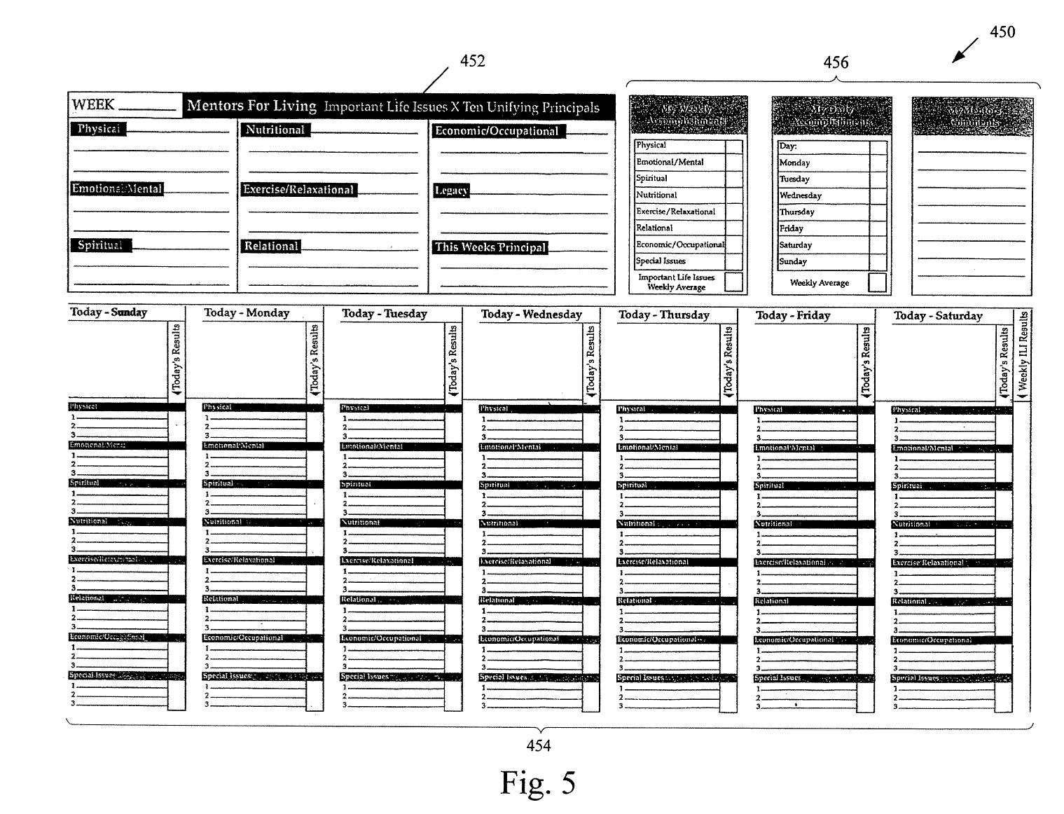

System 100 provides feedback mechanisms for monitoring and updating the progress of client 110 relative to a coordination plan 114, and for dynamically updating the assessment results of client 110. For example, by implementing a coordination plan 114 and subsequently updating current scores 220 of assessment data 200, average current scores 310 would drift outwards towards average desired score 312. Further, as described below with reference to FIG. 5, client 110 can assess and monitor the progress of client 110.

FIG. 4 illustrates an example table of services data 400 that is an example of data 128 of system 100 and that is suitable for use to improve methods of providing healthcare coordination services. More specifically, services data 400 provides a list of factors and the services that may be recommended to compensate for each factor, to be used by service coordination providers 112 in determining a coordination plan 114. Services data 400 includes wellness/holistic services 410, commercial services 412, factors 414, factors 1 416, factors n 418, and threshold scores 420.

Wellness/holistic services 410 are representative of any alternative healthcare coordination services (e.g., integral) for the diagnosis, treatment, and preventive care of patients, as is known to those skilled in the art, for example, a concentration on a process, rather than a goal that empowers a patient to choose a way of life that integrates the physical, psychological, and spiritual principles that necessitate proactive responsibility for a patient's health. Massage, meditation, and Zen are provided as examples of wellness/holistic services 410.

Commercial services 412 are representative of any conventional healthcare management services for the diagnosis, treatment, and preventive care of patients, as is known to those skilled in the art, for example, a concentration on conventional principles of western medicine that are rooted in research, education, technology, and practice that provide a patient with evidence-based care, support, and guidance representative of a cooperative health practice. Health screening, health advocate, disease monitoring, and mentors for living are provided as examples of commercial services 412.

Within services data 400, factors 414 describe a set of internal factors 210 and external factors 212 that may be remedied through a specific wellness/holistic service 410 or a specific commercial service 412. Factors 414 are utilized algorithmically as a means to solve a recurrent problem actuated by healthcare coordination services system 124.

Factor 1 416 is representative of a first factor associated with a specific wellness/holistic service 410 or a specific commercial service 412 used in providing healthcare coordination services.

Factor n 418 is representative of the infinite number of factors associated with a specific wellness/holistic service 410 or a specific commercial service 412 used in providing healthcare coordination services.

Threshold scores 420 is a numerical value that identifies when to recommend a service, such as a wellness/holistic service 410, to improve a factor, such as an emotional/mental internal factor 210. For example, a service may only be recommended if the client's average current score for the factor is greater than x points or more than the client's average desired score for the factor. Threshold scores 420 allow an algorithm or function, such as those performed by analysis program 136, to compare pre-defined threshold scores 420 to difference 224 calculations across factors; and, if a certain condition or conditions are met, services 116 are automatically recommended for clients 110.

For example, a ‘massage’ wellness/holistic service 410 is recommended to assist with ‘emotional/mental’ internal factor 210 if the client's average current score is between 0.1 and 0.4 points less than the client's desired current score, while a “zen” wellness/holistic service 410 is recommended to assist with ‘emotional/mental’ internal factor 210 if the client's average current score is between 0.4 and 1.0 points less than the client's desired current score. Therefore, in the above example, in which a client wishes to increase the average current score 310 of the ‘emotional/mental’ internal factor 210, a “zen” wellness/holistic service 410 is recommended as a service.

Referring now to FIG. 5, an example periodic tool 450 is shown that can be used by client 110 to monitor the progress of client 110 in one or more of the process areas, including assessment, education, motivation, practice, accountability, measurement, and outcomes. Information from periodic tool 450 can be used for monitoring and updating the progress of client 110 in system 100.

In the example shown, tool 450 is a weekly tool that can be used by client 110 to record progress. Tool 450 includes panels 452, 454, 456 that allows client 110 to periodically track progress.

Panel 452 is broken into sections defining important life issues related to internal and external factors including, for example, physical, emotional/mental, spiritual, nutritional, exercise/relaxation, relational, economical/occupational, and legacy. Panel 452 also includes a section for recording one of a plurality of principles that is being focused on for the week.

Client 10 can record specific educational experiences related to the principle that is selected for the week. Examples of the principles include: accepting help; hope; trust; self-esteem, honesty, integrity, communication, resiliency, fulfillment; and self expression. The principles are applied to the life issues listed in panel 452. For example, if the principle of the week is resiliency and client 110 reads a portion of a book on maintaining a diet that is nutritional, client 110 records the reading in the nutritional section of panel 452.

Panel 454 of tool 450 includes a section for each day of the week. For each day, each of the important life issues from panel 452 is listed. Three lines (numbered 1-3) are provided for each life issue, and a box (“Today's Results”) is provided adjacent to each life issue. Client 110 can record specific daily experiences that relate to one or more of the life issues listed in panel 452 on the lines for the appropriate day and life issue. After each day, client 10 can rank the results for each life issue based on the experiences for the day. For example, client 110 can rank from 1 to 10 how well client 110 focused on each life issue for each day in panel 454.

Panel 456 of tool 450 includes sections that allow client 110 to record averages of the rankings for each life issue and each day. For example, a first section lists each life issue from panel 454 and allows client 110 to record the average score for each life issue for the week. A second section lists each day and allows client 110 to record the average score for each day of the week. Panel 456 also includes a section that allows client 110 to record comments for a mentor.

In example embodiments, client 110 reviews and updates information on tool 450 daily. Information from tool 450 can be used to for monitoring and updating the progress of client 110 in system 100. For example, the weekly averages from panel 456 can be fed into system 100 to update assessment results chart 300.

In example embodiments, multiple copies of tool 450 are bound in a binder that allows client 110 to record progress daily in the binder. In alternative embodiments, tool 450 can be implemented as a program on a computer system. In such embodiments, tool 450 can be programmed to automatically calculate averages once client 110 enters rankings for each life issue for each day. Tool 450 can also be programmed to automatically populate suggested educational experiences in panel 452 based on the progress and experiences of client 110.

The basic operation of system 100 is as follows. Service coordination providers 112 gather information for data entry and retrieval through interaction with clients 110. For example, service coordination providers 112 may interview clients 110, request that they complete at least one or more questionnaires, and perform at least one or more examinations on clients 110, Once the information gathering process is satisfactory, service coordination provider 112 populates healthcare coordination services system 124 with data 128 via assessment programs 134. An example of data 128 is assessment data 200.

As a result of the information gathering and population of data 128, healthcare coordination services system 124 is utilized in generating coordination plan 114 and services 116 via programs 132. The basic operation of assessment data 200, assessment results 300, and services data 400 are incorporated into the functionality of system 100 for healthcare coordination services system 124 as data 128 which is generated from output device 130 via programs 132. Assessment data 200 is a feature of assessment program 134. Assessment results 300 is a feature of assessment program 134. Services data 400 is a feature of analysis program 136. Assessment data 200, assessment results 300 and services data 400 are features of graphical program 138.

FIG. 6 illustrates a flow diagram of an example method 500 of providing personal healthcare coordination services. At step 510, service coordination providers 112 interview clients 110 by asking a series of questions 214 that are related to internal factors 210 and external factors 212 that affect clients 110, as is known to those skilled in the art. For example, service coordination providers 112 interview clients 110 by asking questions 214, such as requesting that clients 110 complete at least one or more questionnaires, with the objective of receiving sufficient data 128 to calculate current scores 220 and desired scores 222 and to prepare coordination plan 114 and recommend services 116. Method 500 proceeds to step 512.

At step 512, service coordination providers 112 collect data 128 for clients 110, as described in step 510. For example, service coordination providers 112 utilize components of healthcare coordination services system 124, such as entering data 128 via programs 132 to storage device 126, based on the outcomes of questions 214, with the objective of receiving sufficient data 128 to calculate current scores 220, desired scores 222 and to prepare coordination plan 114 and recommend referral services 116. Method 500 proceeds to step 514.

At step 514, service coordination providers 112 assess data 128, as is known to those skilled in the art, for clients 110. For example, service coordination providers 112 utilize assessment program 134 of healthcare coordination services system 124, such as assessment results chart 300, by retrieving data 128 via output device 130 from storage device 126. Method 500 proceeds to step 516.

At step 516, service coordination providers 112 determine whether a referral is needed by the data assessment of client 110, as described in step 514. A referral may be required if, for example, services needed are outside of or in addition to those that are offered by service coordination providers 112 and they require referral providers 118. If yes, method 500 proceeds to step 526. If no, method 500 proceeds to step 518.

At step 518, service coordination providers 112 analyze data, as is known to those skilled in the art, for client 110. For example, service coordination providers 112 utilize components of healthcare coordination services system 124, such as analysis program 136 via programs 132, by retrieving data 128 via output device 130 from storage device 126, based on the outcomes of questions 214, with the objective of processing data 128 in order to calculate difference 224, prepare coordination plan 114, and recommend referral services 116. Method 500 proceeds to step 520.

At step 520, service coordination providers 112 develop coordination plan 114 for client 110. For example, service coordination providers 112 utilize components of healthcare coordination services system 124, such as assessment program 134, analysis program 136 and graphical 142, via programs 132, by retrieving data 128 via output device 130 from storage device 126, according to assessment data 200, services data 400, and assessment results chart 300. Method 500 proceeds to step 522.

At step 522, service coordination providers 112 recommend services, as is known to those skilled in the art, for clients 10. For example, service coordination providers 112 act in accordance with coordination plan 114 to provide healthcare coordination services for the diagnosis, treatment, and preventive care of patients, according to assessment data 200, services data 400, and assessment results chart 300, based on the outcomes of questions 214, with the objective of processing data 128 to calculate threshold scores 420, which is described in more detail in reference to FIGS. 2-5. Method 500 proceeds to step 524.

At step 524, service coordination providers 112 determine whether a referral is needed, by assessing data 128, analyzing data 128, and developing coordination plan 114 of clients 110. If yes, method 500 proceeds to step 526. If no, method 500 proceeds to step 528.

At optional step 526, service coordination providers 112 refer clients 110 to referral providers 118. For example, service coordination providers 112 act in accordance with coordination plan 114 to utilize components of healthcare coordination services system 124 and query and retrieve data 128 via output device 130 from storage device 126, such as the contact information for referral providers 118. Method 500 proceeds to step 530.

At step 528, services are provided for client 110 by the healthcare provides recommended by coordination providers 112. For example, referred healthcare providers act in accordance with coordination plan 114 to provide healthcare coordination services for the diagnosis, treatment, and preventive care of patients, according to assessment data 200, services data 400, and assessment results chart 300. Method 500 proceeds to step 530.

At step 530, service coordination providers 112 assess services, as is known to those skilled in the art, that are provided by service coordination providers 112 and/or referral providers 118 as satisfactory or unsatisfactory, based on the progress of services 116 and/or referral services 122 for clients 110. For example, service coordination providers 112 utilize components of healthcare coordination services system 124, such as assessment program 134 via programs 132. Method 500 proceeds to step 532.

At step 532, service coordination providers 112 determine whether coordination plan 114 and/or referral services plan 120 that are provided by service coordination providers 112 and/or referral providers 118 need updating, by assessing services 116 and/or referral services 122 for clients 110. Service coordination providers 112 can also analyze self-assessments by clients 110. If yes, method 500 returns to step 520. If no, method 500 ends.

Although the example embodiments are described herein with respect to the coordination of healthcare services, the principles illustrated herein are not limited to physical and/or spiritual healthcare. In other embodiments, other aspects of life can be enhanced in similar manners. For example, in alternative embodiments, a client's financial health can be coordinated using the systems and methods described herein. The client can undergo an initial assessment of the client's financial health, and a coordination plan can be developed based on the assessment. The client can be referred to service providers and can perform self-assessments to enhance the client's financial health. Other applications are also possible.

The various embodiments described above are provided by way of illustration only and should not be construed to limiting. Those skilled in the art will readily recognize various modifications and changes that may be made to the embodiments described above without departing from the true spirit and scope of the disclosure or the following claims.

What is claimed is:

1. A computer system for coordinating healthcare and services for an individual, the computer system comprising:
an assessment module programmed to collect data from the individual associated with internal and external factors related to the individual;
an analysis module programmed to analyze the data and to recommend services based on the analysis; and
a graphical module programmed to graphically represent the analyzed data.

2. The computer system of claim 1, wherein the internal factors include emotional/mental, physical, and spiritual.

3. The computer system of claim 1, wherein the external factors include occupational, relational, and economics.

4. The computer system of claim 1, wherein the assessment module is further programmed to collect the data from the individual by using a series of questions.

5. The computer system of claim 1, wherein the analysis module is further programmed to refer the individual to a referral provider.

6. The computer system of claim 1, wherein the graphical module is further programmed to generate an assessment results chart to graphically represent the analyzed data.

7. The computer system of claim 6, wherein the assessment results chart includes representations of average current scores and average desired scores for the individual.

8. The computer system of claim 1, further comprising a tool configured to allow the individual to monitor progress for the individual.

9. The computer system of claim 8, wherein the tool is further configured to allow the individual to monitor progress for both the internal and external factors associated with the individual.

10. The computer system of claim 8, wherein the analysis module is further programmed to update the analysis of the data based on data collected by the tool.

11. A computer system for coordinating healthcare and services for an individual, the computer system comprising:
an assessment module programmed to collect data from the individual associated with internal and external factors related to the individual using a series of questions, wherein the internal factors include emotional/mental, physical, and spiritual, and wherein the external factors include occupational, relational, and economics;
an analysis module programmed to analyze the data and to recommend services based on the analysis; and
a graphical module programmed to generate an assessment results chart to graphically represent the analyzed data, wherein the assessment results chart includes representations of average current scores and average desired scores for the individual.

12. The computer system of claim 11, further comprising a tool configured to allow the individual to monitor progress for the individual.

13. The computer system of claim 12, wherein the tool is further configured to allow the individual to monitor progress for both the internal and external factors associated with the individual.

14. The computer system of claim 12, wherein the analysis module is further programmed to update the analysis of the data based on data collected by the tool.

15. A method for coordinating healthcare and services for an individual, the method comprising:
collecting data from the individual associated with internal and external factors related to the individual;
analyzing the data to recommend services; and
generating a graphical representation of the analyzed data.

16. The method of claim 15, wherein the internal factors include emotional/mental, physical, and spiritual.

17. The method of claim 15, wherein the external factors include occupational, relational, and economics.

18. The method of claim 15, wherein the graphical representation includes average current scores and average desired scores for the individual.

19. The method of claim 15, further comprising allowing the individual to monitor progress for the individual.

20. The method of claim 19, further comprising allowing the individual to monitor progress for the individual for both the internal and external factors associated with the individual.
